(19) United States
(12) Patent Application Publication
(10) Pub. No.: US 2020/0059950 A1
(43) Pub. Date: Feb. 20, 2020

(54) DYNAMIC ALLOCATION IN DENSE MMWAVE NETWORKS

(71) Applicant: INTERDIGITAL PATENT HOLDINGS, INC., Wilmington, DE (US)

(72) Inventors: Oghenekome Oteri, San Diego, CA (US); Hanqing Lou, Syosset, NY (US); Li-Hsiang Sun, San Diego, CA (US); Rui Yang, Greenlawn, NY (US)

(73) Assignee: INTERDIGITAL PATENT HOLDINGS, INC., Wilmington, DE (US)

(21) Appl. No.: 16/347,079

(22) PCT Filed: Nov. 2, 2017
(86) PCT No.: PCT/US2017/059799

§ 371 Date: May 2, 2019

Related U.S. Application Data
(60) Provisional application No. 62/416,934, filed on Nov. 3, 2016.

(51) Int. Cl. H04W 72/12; H04W 74/08

(52) U.S. Cl. CPC H04W 72/1289; H04W 84/12; H04W 74/08; H04W 72/1284

(57) ABSTRACT

Systems, methods, and/or instrumentalities are disclosed for dynamic allocation (e.g. of communication channel time with an access point (AP)) to a plurality of wireless transmit/receive units (STA(s)/WTRUs) in dense mmWave networks. Dynamic allocation may be implemented in multiple (e.g. four) sub-phases, (e.g. a polling period sub-phase with polls, a polling period sub-phase with service period requests (SPRs), a grant sub-phase and/or a data transfer sub-phase). Multi-dimensional dynamic allocation may address multiple STAs simultaneously (e.g. using one or more different dimensions such as space, frequency, and/or code). Directional channel access may provide a contention-based uplink in which STAs compete (e.g. during an uplink request period) to send data requests. Efficient dynamic allocation may optimize signaling and/or operation in sub-phases (e.g. using grouped polling, grouped SPR and/or grouped grant frames). Dynamic allocation with subphase overlap may allow different sub-phases of a dynamic allocation procedure to overlap.

### CROSS-REFERENCE TO RELATED APPLICATIONS

This application claims the benefit of U.S. Provisional Patent Application No. 62/416,934, filed Nov. 3, 2016, the entire contents of which is hereby incorporated by reference as if fully set-forth herein, for all purposes.

### BACKGROUND

A Wireless Local Area Network (WLAN) may have multiple modes of operation, such as an Infrastructure Basic Service Set (BSS) mode and an Independent BSS (IBSS) mode. A WLAN in Infrastructure BSS mode may have an Access Point (AP) for the BSS. One or more wireless transmit receive units (WTRUs), e.g., stations (STAs), may be associated with an AP. An AP may have access and/or an interface to a Distribution System (DS) and/or other type of wired/wireless network that carries traffic in and out of a BSS. Traffic to STAs that originates from outside a BSS may arrive through an AP, which may deliver the traffic to the STAs. STA to STA communication may occur in a WLAN system. An AP may act in the role of a STA in a WLAN system. Beamforming may be used by WLAN devices.

### SUMMARY

Systems, methods, and/or instrumentalities are disclosed for dynamic allocation (e.g. of communication channel time with an access point (AP)) to a plurality of wireless transmit/receive units (WTRUs), e.g., in dense mmWave (mmW) networks. Dynamic allocation may be implemented in multiple (e.g. four) sub-phases, (e.g. a polling period sub-phase with polls, a polling period sub-phase with service period requests (SPRs), a grant sub-phase and/or a data transfer sub-phase). Multi-dimensional dynamic allocation may address multiple STAs simultaneously (e.g. using one or more different dimensions such as space, frequency, and/or code). Directional channel access may provide a contention-based uplink in which STAs compete (e.g. during an uplink request period) to send data requests. Efficient dynamic allocation may optimize signaling and/or operation in sub-phases (e.g. using grouped polling, grouped SPR and/or grouped grant frames). Dynamic allocation with subphase overlap may allow different sub-phases of a dynamic allocation procedure to overlap.

A STA may comprise a memory. The STA may comprise a receiver. The receiver may be configured to detect an indication of one or more Uplink Request Periods (ULP) from an Access Point (AP). The STA may comprise a processor. The processor may be configured to determine an occurrence of at least one ULP of the one or more ULP. The processor may be configured to determine an eligibility to request one or more transmission resources in the at least one ULP. The processor may be configured to initiate a request for the one or more transmission resources upon the determination indicating the eligibility. The STA may comprise a transmitter. The transmitter may be configured to send the request for the one or more transmission resources in a contention-based uplink (UL) signal in the at least one ULP.

An AP may comprise a memory. The AP may comprise a processor. The processor may be configured to provide an indication of one or more Uplink Request Periods (ULP) to a plurality of stations (STA). The one or more ULP may be dedicated periods for requests of one or more transmission resources. The processor may be configured to determine one or more STA groups based on the plurality of STA. The STA may comprise a receiver. The receiver may be configured to detect one or more requests for the one or more transmission resources in one or more contention-based uplink (UL) signals from one or more STA of the plurality of STA in at least one ULP via one or more AP receive antenna. The processor may be further configured to provide an indication of the one or more transmission resources to the one or more STA. The STA may comprise a transmitter. The transmitter may be configured to send the indication of the one or more transmission resources to the one or more STA.

### BRIEF DESCRIPTION OF THE DRAWINGS

FIG. 1A is a system diagram illustrating an example communications system in which at least some disclosed subject matter may be implemented.

FIG. 1B is a system diagram illustrating an example communications system in which at least some of the disclosed subject matter may be implemented.

FIG. 1C is a system diagram illustrating an example wireless transmit/receive unit (WTRU) that may be used within the communications system illustrated in FIGS. 1A, 1B, 1D, and/or 1E.

FIG. 1D is a system diagram illustrating an example radio access network (RAN) and an example core network (CN) that may be used within the communications system illustrated in FIG. 1A and/or FIG. 1C according to the disclosed subject matter.

FIG. 1E is a system diagram illustrating an example RAN and an example CN that may be used within the communications system illustrated in FIG. 1A and/or FIG. 1C according to the disclosed subject matter.

FIG. 2 is an example of PLCP Protocol Data Unit (PPDU) formats.

FIG. 3 is an example of a Directional Multi Gigabit (DMG) channel access scheme.

FIG. 4 is an example of dynamic allocation of a service period in 802.11ad.

FIG. 5 is an example of a Poll frame format in 802.11ad.

FIG. 6 is an example of Service Period Request (SPR) frame format in 802.11ad.

FIG. 7 is an example of grant frame format in 802.11ad.

FIG. 8 is an example of channel bonding versus aggregation framework.

FIG. 9 provides examples of channel bonding.

FIG. 10 is an example of channelization.

FIG. 11 is an example of multi-dimensional dynamic allocation with multi-dimensional data transfer.

FIG. 12 is an example of an Uplink Request Period in a Data Transmission Interval (DTI).

FIG. 13 is an example of an Uplink Request Period as a useful access period.

FIG. 14 is an example of an Uplink Request Period being omitted in some Beacon Intervals.

FIG. 15 is an example of a grouped poll.

FIG. 16 is an example of a grouped poll with STA indices.

FIG. 17 is an example of an efficient Dynamic Allocation (DA) Procedure.

FIG. 18 is an example of a Dynamic Allocation with sub-phase overlap using Spatial Reuse.

FIG. 19 is an example of Dynamic Allocation with sub-phase overlap using frequency.

FIG. 20 is an example of optimizing the start of data transmission by sub-phase overlap using one or more different dimensions.

FIG. 21 is an example technique of DA with contention and/or multi-dimensional grants/transmission.

FIG. 22 is an example of multi-dimensional dynamic allocation with multi-dimensional data transfer with ULP data request.

### DETAILED DESCRIPTION

A detailed description of illustrative examples will now be described with reference to the various Figures. Although this description provides a detailed example of possible implementations, it should be noted that the details are intended to be examples and in no way limit the scope of the application.

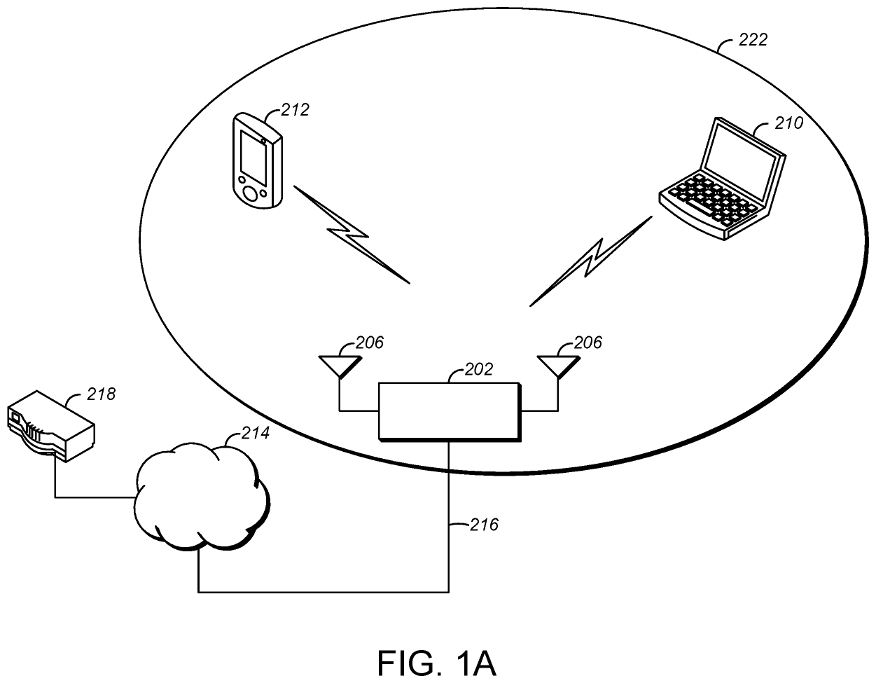

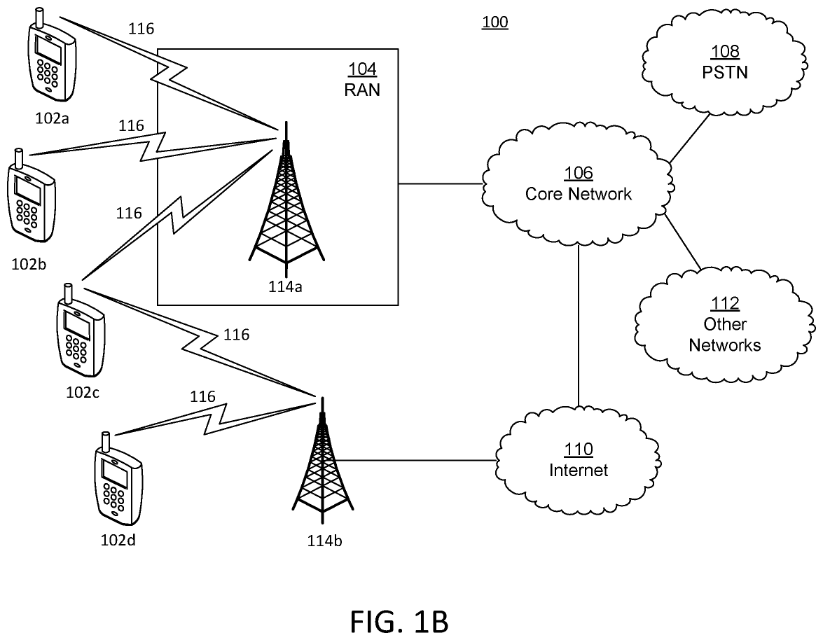

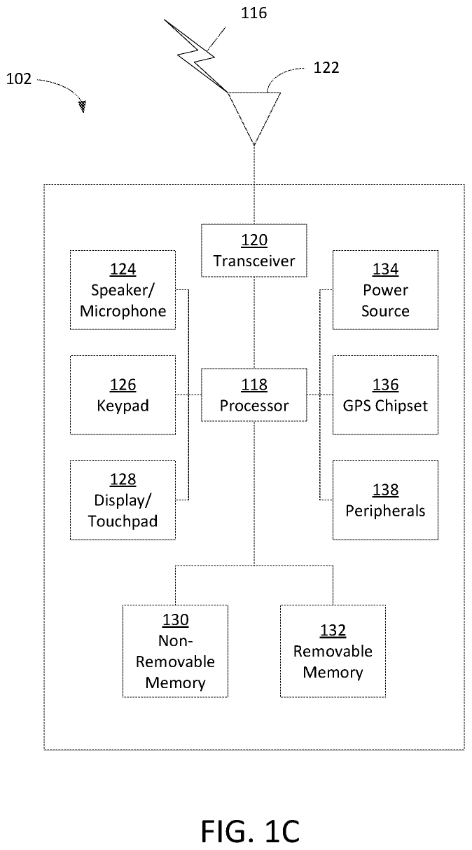

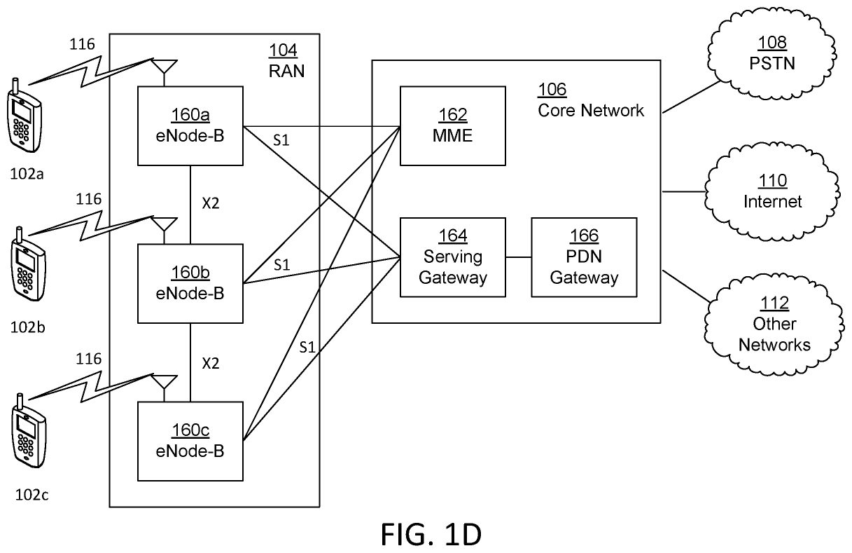

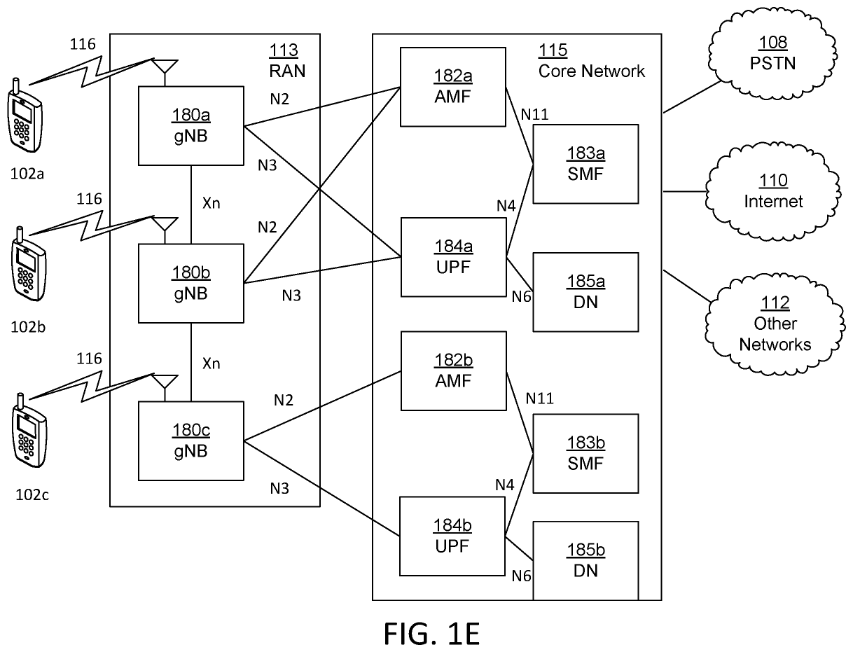

FIG. 1A illustrates example wireless local area network (WLAN) devices. One or more of the devices may be used to implement one or more of the features described herein. The WLAN may include, but is not limited to, access point (AP) 202, station (STA) 210, and STA 212. STA 210 and 212 may be associated with AP 202. The WLAN may be configured to implement one or more protocols of the IEEE 802.11 communication standard, which may include a channel access scheme, such as DSSS, OFDM, OFDMA, etc. A WLAN may operate in a mode, e.g., an infrastructure mode, an ad-hoc mode, etc.

A WLAN operating in an infrastructure mode may comprise one or more APs communicating with one or more associated STAs. An AP and STA(s) associated with the AP may comprise a basic service set (BSS). For example, AP 202, STA 210, and STA 212 may comprise BSS 222. An extended service set (ESS) may comprise one or more APs (with one or more BSSs) and STA(s) associated with the APs. An AP may have access to, and/or interface to, distribution system (DS) 216, which may be wired and/or wireless and may carry traffic to and/or from the AP. Traffic to a STA in the WLAN originating from outside the WLAN may be received at an AP in the WLAN, which may send the traffic to the STA in the WLAN. Traffic originating from a STA in the WLAN to a destination outside the WLAN, e.g., to server 218, may be sent to an AP in the WLAN, which may send the traffic to the destination, e.g., via DS 216 to network 214 to be sent to server 218. Traffic between STAs within the WLAN may be sent through one or more APs. For example, a source STA (e.g., STA 210) may have traffic intended for a destination STA (e.g., STA 212). STA 210 may send the traffic to AP 202, and, AP 202 may send the traffic to STA 212.

A WLAN may operate in an ad-hoc mode. The ad-hoc mode WLAN may be referred to as independent basic service set (IBBS). In an ad-hoc mode WLAN, the STAs may communicate directly with each other (e.g., STA 210 may communicate with STA 212 without such communication being routed through an AP).

IEEE 802.11 devices (e.g., IEEE 802.11 APs in a BSS) may use beacon frames to announce the existence of a WLAN network. An AP, such as AP 202, may transmit a beacon on a channel, e.g., a fixed channel, such as a primary channel. A STA may use a channel, such as the primary channel, to establish a connection with an AP.

STA(s) and/or AP(s) may use a Carrier Sense Multiple Access with Collision Avoidance (CSMA/CA) channel access mechanism. In CSMA/CA a STA and/or an AP may sense the primary channel. For example, if a STA has data to send, the STA may sense the primary channel. If the primary channel is detected to be busy, the STA may back off. For example, a WLAN or portion thereof may be configured so that one STA may transmit at a given time, e.g., in a given BSS. Channel access may include RTS and/or CTS signaling. For example, an exchange of a request to send (RTS) frame may be transmitted by a sending device and a clear to send (CTS) frame that may be sent by a receiving device. For example, if an AP has data to send to a STA, the AP may send an RTS frame to the STA. If the STA is ready to receive data, the STA may respond with a CTS frame. The CTS frame may include a time value that may alert other STAs to hold off from accessing the medium while the AP initiating the RTS may transmit its data. On receiving the CTS frame from the STA, the AP may send the data to the STA.

A device may reserve spectrum via a network allocation vector (NAV) field. For example, in an IEEE 802.11 frame, the NAV field may be used to reserve a channel for a time period. A STA that wants to transmit data may set the NAV to the time for which it may expect to use the channel. When a STA sets the NAV, the NAV may be set for an associated WLAN or subset thereof (e.g., a BSS). Other STAs may count down the NAV to zero. When the counter reaches a value of zero, the NAV functionality may indicate to the other STA that the channel is now available.

The devices in a WLAN, such as an AP and/or STA, may include one or more of the following: a processor, a memory, a radio receiver and/or transmitter (e.g., which may be combined in a transceiver), one or more antennas (e.g., antennas 206 in FIG. 1A), etc. A processor function may comprise one or more processors. For example, the processor may comprise one or more of: a general purpose processor, a special purpose processor (e.g., a baseband processor, a MAC processor, etc.), a digital signal processor (DSP), Application Specific Integrated Circuits (ASICs), Field Programmable Gate Array (FPGAs) circuits, any other type of integrated circuit (IC), a state machine, and the like. The one or more processors may be integrated or not integrated with each other. The processor (e.g., the one or more processors and/or a subset thereof) may be integrated with one or more other functions (e.g., other functions such as memory). The processor may perform signal coding, data processing, power control, input/output processing, modulation, demodulation, and/or any other functionality that may enable the device to operate in a wireless environment, such as the WLAN of FIG. 1A. The processor may be configured to execute processor executable code (e.g., instructions) including, for example, software and/or firmware instructions. For example, the processer may be configured to execute computer readable instructions included on one or more of the processor (e.g., a chipset that includes memory and a processor) and/or memory. Execution of the instructions may cause the device to perform one or more of the functions described herein.

A device may include one or more antennas. The device may employ multiple input multiple output (MIMO) techniques. The one or more antennas may receive a radio signal. The processor may receive the radio signal, e.g., via the one or more antennas. The one or more antennas may transmit a radio signal (e.g., based on a signal sent from the processor).

The device may have a memory that may include one or more devices for storing programming and/or data, such as processor executable code and/or instructions (e.g., software, firmware, etc.), electronic data, databases, and/or other digital information. The memory may include one or more memory units. One or more memory units may be integrated with one or more other functions (e.g., other functions included in the device, such as the processor). The memory may include a read-only memory (ROM) (e.g., erasable programmable read only memory (EPROM), electrically erasable programmable read only memory (EEPROM), etc.), random access memory (RAM), magnetic disk storage media, optical storage media, flash memory devices, and/or other non-transitory computer-readable media for storing information. The memory may be coupled to the processer. The processer may communicate with one or more entities of memory, e.g., via a system bus, directly, etc.

FIG. 1B is a diagram illustrating an example communications system 100 in which at least some of the disclosed subject matter may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1B, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed subject matter contemplates any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot and/or Mi-Fi device, an Internet of Things (IoT) device, a watch and/or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, and/or a combination of licensed and unlicensed spectrum. A cell may provide coverage for a wireless service to a specific geographical area that may be relatively fixed and/or that may change over time. The cell may further be divided into cell sectors. For example, the cell associated with the base station 114a may be divided into three sectors. The base station 114a may include three transceivers, i.e., one for each sector of the cell. The base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

The base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

The base station 114a and the WTRUs 102a, 102b, 102c may implement a radio technology such as NR Radio Access, which may establish the air interface 116 using New Radio (NR).

The base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

The base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1B may be a wireless router, Home Node B, Home eNode B, and/or access point, for example, and may utilize any suitable RAT for facilitating wireless connectivity in a localized area, such as a place of business, a home, a vehicle, a campus, an industrial facility, an air corridor (e.g., for use by drones), a roadway, and the like. The base station 114b and the WTRUs 102c, 102d may implement a radio technology such as IEEE 802.11 to establish a wireless local area network (WLAN). The base station 114b and the WTRUs 102c, 102d may implement a radio technology such as IEEE 802.15 to establish a wireless personal area network (WPAN). The base station 114b and the WTRUs 102c, 102d may utilize a cellular-based RAT (e.g., WCDMA, CDMA2000, GSM, LTE, LTE-A, LTE-A Pro, NR etc.) to establish a picocell and/or femtocell. As shown in FIG. 1B, the base station 114b may have a direct connection to the Internet 110. Thus, the base station 114b might not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1B, it will be appreciated that the RAN 104/113 and/or the CN 106/115 may be in direct and/or indirect communication with other RANs that employ the same RAT as the RAN 104/113 and/or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, and/or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 and/or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1B may be configured to communicate with the base station 114a, which may employ a cellular-based radio technology, and with the base station 114b, which may employ an IEEE 802 radio technology.

FIG. 1C is a system diagram illustrating an example WTRU 102. As shown in FIG. 1C, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with the disclosed subject matter.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1C depicts the processor 118 and the transceiver 120 as separate components, it will be appreciated that the processor 118 and the transceiver 120 may be integrated together in an electronic package and/or chip.

The transmit/receive element 122 may be configured to transmit signals to, and/or receive signals from, a base station (e.g., the base station 114a) over the air interface 116. For example, the transmit/receive element 122 may be an antenna configured to transmit and/or receive RF signals. The transmit/receive element 122 may be an emitter/detector configured to transmit and/or receive IR, UV, and/or visible light signals, for example. The transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1C as a single element, the WTRU 102 may include any number of transmit/receive elements 122. More specifically, the WTRU 102 may employ MIMO technology. The WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit and/or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, and/or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server and/or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with the disclosed subject matter.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and/or substantially eliminate self-interference via either hardware (e.g., a choke) and/or signal processing via a processor (e.g., a separate processor (not shown) and/or via processor 118). The WRTU 102 may include a half-duplex radio for which transmission and/or reception of some or all of the signals (e.g., associated with particular subframes for either the UL (e.g., for transmission) and/or the downlink (e.g., for reception)).

FIG. 1D is a system diagram illustrating the RAN 104 and the CN 106 according to the disclosed subject matter. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with the disclosed subject matter. The eNode-Bs 160a, 160b, 160c may each include one or more transceivers for communicating with the WTRUs 102a, 102b, 102c over the air interface 116. The eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1D, the eNode-Bs 160a, 160b, 160c may communicate with one another over an X2 interface.

The CN 106 shown in FIG. 1D may include a mobility management entity (MME) 162, a serving gateway (SGW) 164, and a packet data network (PDN) gateway (and/or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, and/or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1E as a wireless terminal, it is contemplated that in at least some of the disclosed subject matter that such a terminal may use (e.g., temporarily and/or permanently) wired communication interfaces with the communication network.

In at least some disclosed subject matter, the other network 112 may be a WLAN.

A WLAN in Infrastructure Basic Service Set (BSS) mode may have an Access Point (AP) for the BSS and one or more stations (STAs) associated with the AP. The AP may have an access and/or an interface to a Distribution System (DS) and/or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). The DLS may use an 802.11e DLS and/or an 802.11z tunneled DLS (TDLS). A WLAN using an Independent BSS (IBSS) mode might not have an AP, and the STAs (e.g., one or more, or all of the STAs) within and/or using the IBSS may communicate directly with each other. The IBSS mode of communication may sometimes be referred to herein as an “ad-hoc” mode of communication.

When using the 802.11ac infrastructure mode of operation and/or a similar mode of operations, the AP may transmit a beacon on a fixed channel, such as a primary channel. The primary channel may be a fixed width (e.g., 20 MHz wide bandwidth) and/or a dynamically set width via signaling. The primary channel may be the operating channel of the BSS and may be used by the STAs to establish a connection with the AP. Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, and/or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. In at least some disclosed subject matter, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by one or more, or all STAs in the BSS. The bandwidth of the primary channel may be set and/or limited by a STA, from among one or more, or all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1E is a system diagram illustrating the RAN 113 and the CN 115 according to at least some disclosed subject matter. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with the disclosed subject matter. The gNBs 180a, 180b, 180c may each include one or more transceivers for communicating with the WTRUs 102a, 102b, 102c over the air interface 116. The gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. The gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. The gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe and/or transmission time intervals (TTIs) of various and/or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1E, the gNBs 180a, 180b, 180c may communicate with one another over an Xn interface.

The CN 115 shown in FIG. 1E may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, and/or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. The WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1E, and the corresponding description of FIGS. 1A-1E, one or more, or all, of the functions described herein with regard to one or more of: AP 202, STA 210, STA 212, Server 218, WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

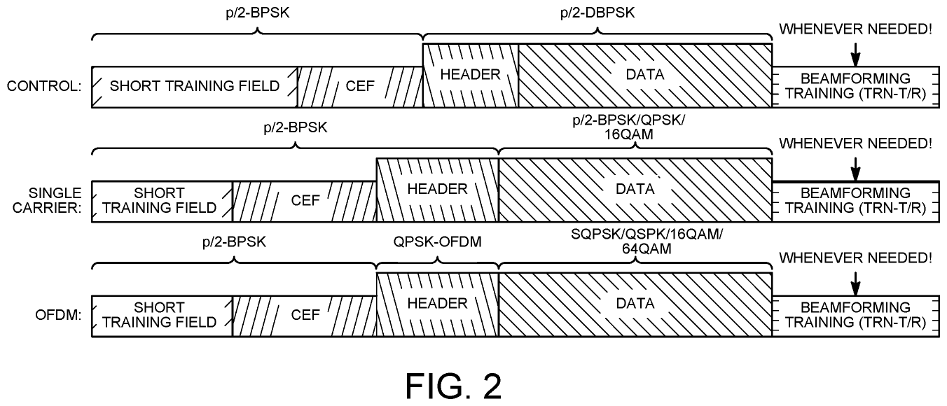

FIG. 2 is an example of PPDU formats. 802.11ad may support three PPDU formats, e.g., Control PHY, Single Carrier (SC) PHY and/or OFDM PHY PPDUs.

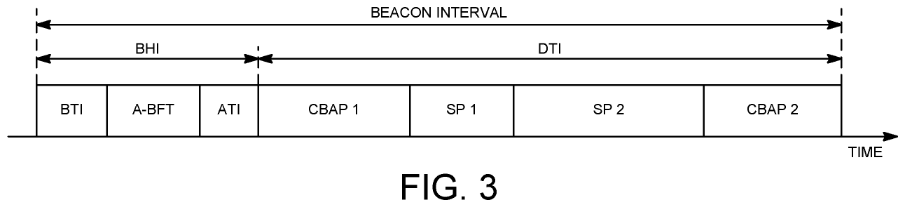

FIG. 3 is an example of a DMG channel access scheme. 802.11ad may support a DMG channel access scheme within a beacon interval.

A Beacon Transmission Interval (BTI) may be an access period during which one or more DMG Beacon frames may be transmitted. DMG Beacon frames might not be detectable by one or more, or all non-PCP and/or non-AP STAs. One or more beacon intervals might not contain a BTI. A non-PCP STA that may be a non-AP STA might not transmit during the BTI of the BSS of which it is a member.

An Association Beamforming Training Time (A-BFT) may be an access period during which beamforming training may be performed with a STA that may have transmitted a DMG Beacon frame during a preceding BTI. An A-BFT, perhaps when useful, may be signaled in DMG Beacon frames.

An Announcement Transmission Interval (ATI) may be a request-response based management access period between personal basic service set control point (PCP)/access point (AP) (PCP/AP) and non-PCP/non-AP STAs. An ATI, perhaps when useful, may be signaled in DMG Beacon frames.

A DTI may be an access period during which frame exchanges may be performed between STAs. There may be a (e.g. single) DTI per beacon interval. A DTI may (e.g. in turn) comprise contention-based access periods (CBAPs) and/or scheduled service periods (SPs).

One or more service periods (SPs) and/or CBAPs may be used for dynamic allocation. Dynamic allocation may be used to allow for near real time reservation of channel time with a PCP/AP. This type of access may be used, for example, in addition to the SPs and/or CBAPs.

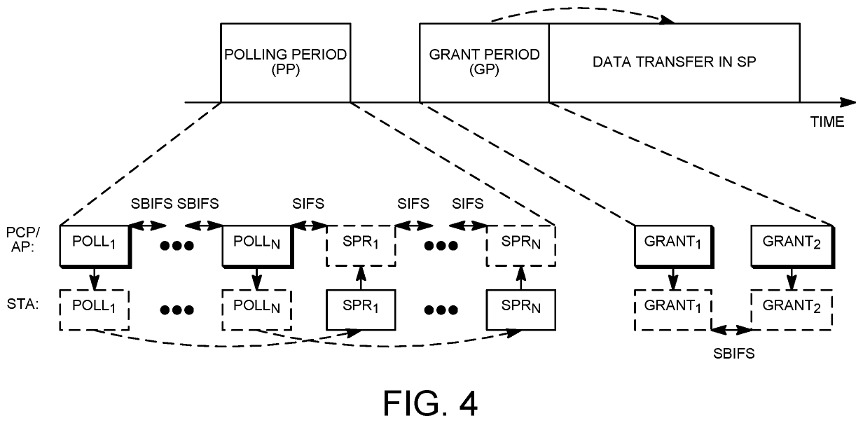

FIG. 4 is an example of dynamic allocation of a service period in 802.11ad. A PCP/AP may poll STAs and/or may receive requests for channel time allocation. A PCP/AP may (e.g. based on received requests) accept a request and/or may (e.g. immediately) allocate channel time for a STA to communicate with another STA, e.g., by using the grant frame.

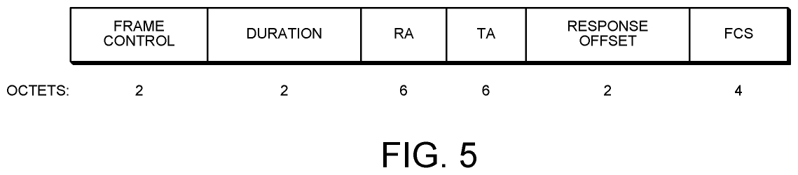

FIG. 5 is an example of a Poll frame format in 802.11ad.

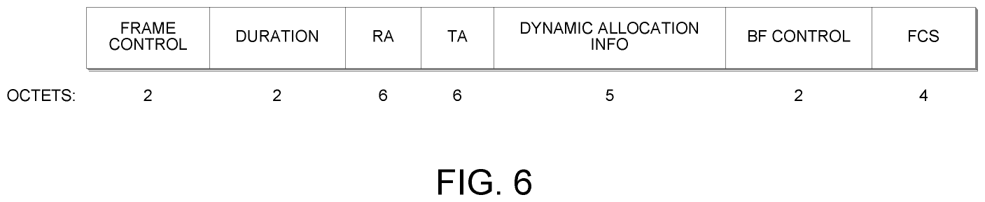

FIG. 6 is an example of Service Period Request (SPR) frame format in 802.11ad.

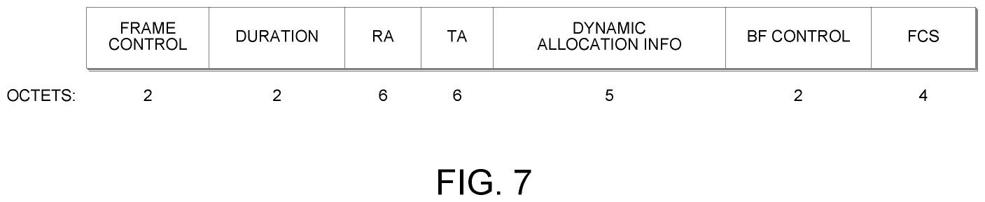

FIG. 7 is an example of grant frame format in 802.11ad.

An IEEE 802.11ay physical layer (PHY) and/or an IEEE 802.11ay medium access control layer (MAC) may have at least one mode of operation capable of supporting a maximum throughput of at least 20 gigabits per second (e.g. measured at the MAC data service access point) and/or may maintain and/or improve power efficiency (e.g. per station). An IEEE 802.11ay physical layer (PHY) and/or IEEE 802.11ay medium access control layer (MAC) may have license-exempt bands above 45 GHz that may have backward compatibility and/or may coexist with directional multi-gigabit stations (e.g. legacy stations, which may be defined by IEEE 802.11ad) operating in the same band. 802.11ay may operate in the same band as other (e.g. legacy) standards. There may be backward compatibility and/or coexistence with legacy standards in the same band.

802.11ay may support MIMO transmission (e.g. including SU-MIMO and/or MU-MIMO) and/or multi-channel transmission (e.g. including channel bonding and/or channel aggregation).

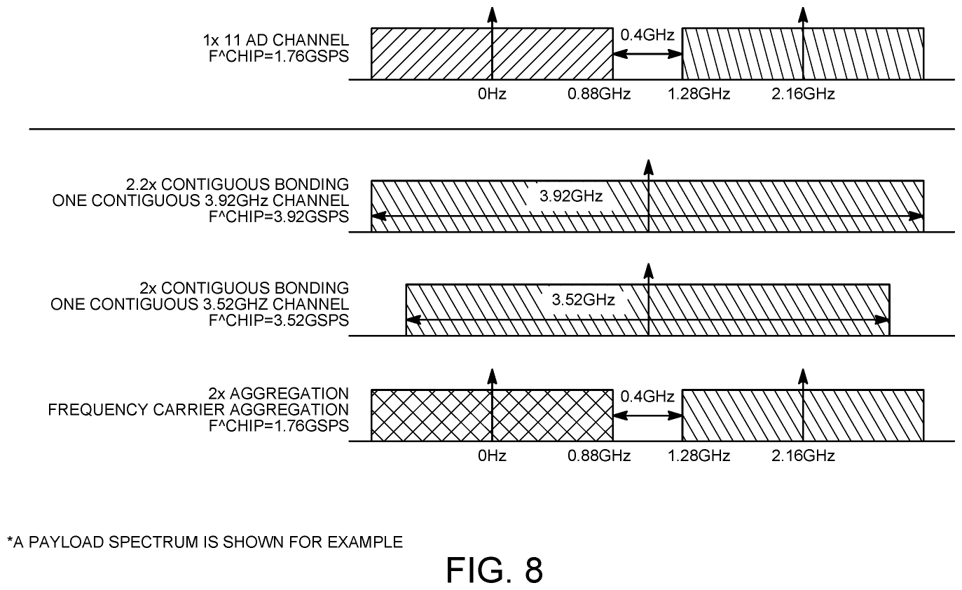

FIG. 8 is an example of channel bonding versus aggregation framework. 802.11ay may support MIMO, channel bonding and/or channel aggregation.

In channel bonding and/or aggregation, for example, a set of Tx/Rx pairs may transmit/receiver over multiple component channels (e.g. bands). A primary channel (e.g. in an 802.11 system) may be a component channel on which full carrier sense (e.g. physical and/or virtual) may be maintained. 802.11 functions (e.g. AP association, probing and/or re-association) may occur on a primary channel.

In channel bonding, for example, a Tx/Rx pair may use multiple component channels as a single transmission channel for data. In channel aggregation, for example, multiple component channels may be used independently (see, e.g., FIGS. 8 and/or 9).

WLANs may support channel bonding data transmission.

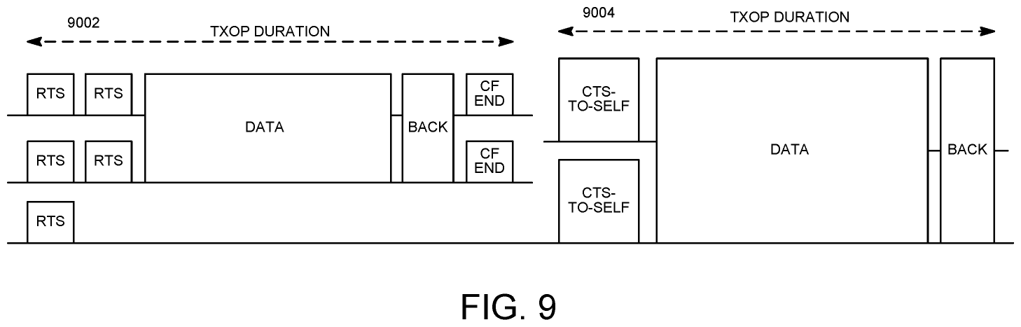

FIG. 9 provides examples of channel bonding. A transmitter may (e.g. as shown in 9002 in FIG. 9) reserve a medium with independent RTS frames on the channels to be bonded. A receiver may reply with a CTS. The transmitter may send a channel bonded data transmission to the receiver. Indication of bonding may be placed, for example, in the RTS and/or in the preamble of the transmitted data frame. The receiver may reply with a channel bonded ACK. The transmitter may reply with two CF-ENDs to end the TxOP reservation.

A transmitter may (e.g. as shown in 9004 in FIG. 9) reserve a medium with CTS-to-self frames on the channels to be bonded. The transmitter may send a channel bonded data transmission to a receiver. Indication of bonding may be placed, for example, in the RTS and/or in the preamble of the transmitted data frame. The receiver may reply with a channel bonded ACK.

Full carrier sense (physical and/or virtual) may be maintained on a primary channel.

An Enhanced Directional Multi-Gigabit (EDMG) STA may transmit a frame to a peer EDMG STA to indicate intent to perform channel bonding transmission to the peer STA. This may allow an EDMG STA to choose to operate over multiple channels after receiving such a frame, which may save power.

802.11ay may support (e.g. when using multiple channels) simultaneous transmission by a PCP and/or an AP to multiple STAs allocated to different channels individually.

802.11ay may support allocation of SP(s) and/or scheduled CBAP(s) over more than one channel and/or over a bonded channel. Allocations may or might not include a primary channel. Source and destination of allocations may (e.g. shall) be different, for example, when allocations over different channels overlap in time. Channels used for allocations may be limited to the operating channels of the BSS.

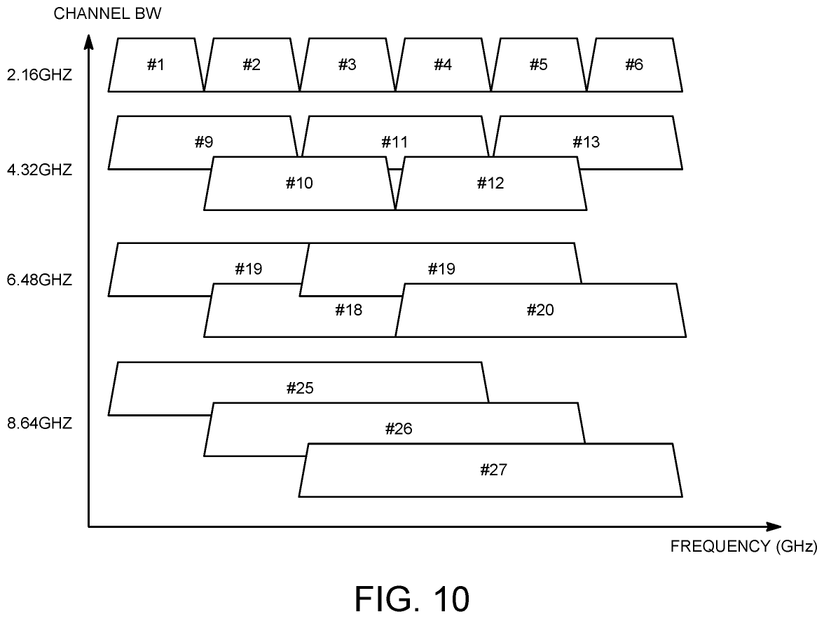

FIG. 10 is an example of channelization. In FIG. 10, the BW/Frequency identification numbers #1-#6, #9-#13, #17-#20, #17-#20, #25-#27 are for example and/or illustration.

Channel bonding and/or channel aggregation may be supported. Examples of channel aggregation modes may be, for example, 2.16 GHz+2.16 GHz, 4.32 GHz+4.32 GHz, 4.32+2.16 GHz aggregation modes. EDMG-Header-A (e.g. a PHY header for EDMG devices) may have, for example, one or more of the following fields: bandwidth; channel bonding (e.g. to differentiate between channel bonding and channel aggregation), and/or primary channel.

Fields may be included in a Control Trailer for RTS/CTS setup. A duplicated RTS/CTS approach may carry the bandwidth information for efficient channel bonding operation.

Directional channel access procedures may be provided. A dynamic allocation procedure may provide a way for STAs to request transmission time in a directional MAC. For example, poll and/or SPR frames may be (e.g. individually) addressed. STAs may reply to polling, for example, even without data to transmit. Efficiency may be improved in a system with densely deployed devices. Efficiency may (e.g. also) be improved for channel access schemes.

Dynamic allocation may be multi-dimensional. Dynamic allocation may be implemented in multiple (e.g. four) sub-phases, which may include one or more of the following: a polling period sub-phase with polls; a polling period sub-phase with service period request (SPRs); a grant sub-phase; and/or a data transfer sub-phase.

Multiple STAs may be addressed simultaneously using different dimensions, for example, to enable low overhead and/or efficient signaling in a dense network. Dimensions may include, for example, space, frequency, and/or code.

Addressing STAs using a space dimension may, for example, use multiple orthogonal beams, e.g., to send/receive packets to/from multiple STAs.

Addressing STAs using a frequency dimension may, for example, use multiple channels (e.g. using channel bonding and/or channel aggregation) and/or multiple subchannels (e.g. OFDMA), e.g., to send/receive packets to/from multiple STAs.

Addressing STAs using a code dimension may, for example, use multiple codes (e.g. orthogonal and/or semi-orthogonal), e.g., to send/receive packets to/from multiple STAs. For example, a golay code may be assigned to a specific user, e.g., to allow simultaneous transmission to multiple users.

A (e.g. single) MAC packet may (e.g. also) be used to send information to more than one STA, for example, for specific packets in a sub-phase. For example, a polling packet in a polling period sub-phase may be addressed (e.g. explicitly) to multiple STAs, for example, by using a group address and/or multiple individual addresses. For example, a polling packet in a polling period sub-phase may be addressed (e.g. implicitly) to multiple STAs, for example, by specifying multiple (e.g. one or more, or all) STAs that may signal a specific sector (e.g. as a best sector in Sector Level Sweep (SLS) and/or Beam Refinement Protocol (BRP) procedures).

More than one dimension type may be used, for example, to improve the performance in dense networks. Using more than one dimension may include, for example, one or more of the following: space and frequency; space and code; frequency and code; and/or space, frequency and code.

An AP/PCP and STA capability frame exchange may occur, for example, to ensure that the PCP/AP and the STAs may be able to communicate in multi-dimensional mode. An AP/PCP may indicate its dynamic allocation dimensional capability in a beacon frame, e.g., to ensure that STAs that join the PCP/AP may be aware of its capabilities.

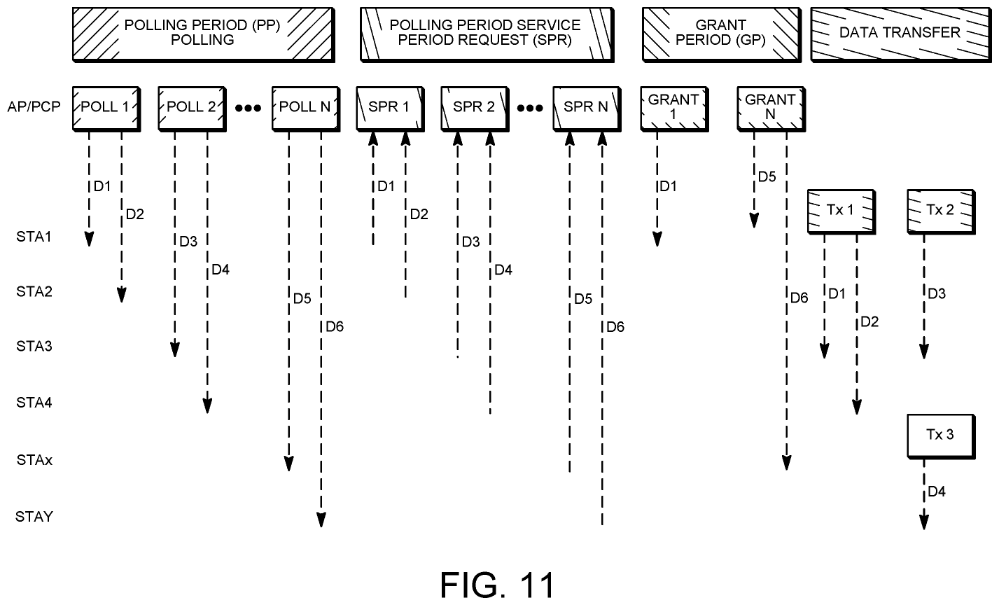

FIG. 11 is an example of multi-dimensional dynamic allocation with multi-dimensional data transfer. This may include one or more of the following: the AP/PCP may send a multi-dimensional polling frame to the STAs (e.g., in the polling period); STAs may reply with a multi-dimensional Service Period Request (SPR) indicating their need for access to the medium; and/or AP/PCP may allocate resources to the STAs (e.g., using a multi-dimensional Grant frame).

An AP/PCP may (e.g. in a polling period) send a multi-dimensional polling frame to one or more STAs. For example, STA1 and STA2 may be polled on dimensions 1 and 2, STA3 and STA 4 may be polled on dimensions 3 and 4 and STAx and STAy may be polled on dimensions 5 and 6. For example, d1=d3=d5 and d2=d4=d6. For example, one or more dimensions may be entirely different (e.g. different sectors). Dimensions used by a STA may be assigned during association. An AP may indicate (e.g. one or more, or all) possible dimensions to be used in a dynamic operation procedure and/or the STA may (e.g. be required to) listen to (e.g. one or more, or all) of them and/or negotiate with the AP on which dimensions it may (e.g. should) be polled on.

STAs may reply with a multi-dimensional Service Period Request (SPR) that may indicate their need for access to the medium (e.g. on same polled dimensions and/or on different dimensions estimated from a polling frame).

An AP/PCP may (e.g. then) allocate resources to STAs, for example, using a multi-dimensional Grant frame. An AP may grant a medium to individual STAs and/or multiple STAs, for example, depending on the capabilities and/or data requests from the one or more STAs. An AP/PCP may grant resources to STA 1, which may (e.g. in turn) transmit data (TX1) to two STAs (e.g. STA 3 and/or STA4). This may be implemented, for example, by using multiple beams and/or multiple channels. An AP/PCP may grant resources to STA1 and/or STAx, which may (e.g. in turn) transmit data to STA3 and/or STAy, e.g., respectively. An AP may use knowledge of spatial reuse properties of STAs, for example, to allocate resources.

Directional channel access mechanisms may be provided, such as an uplink request period for data requests.

STAs may compete to send data requests, for example, using a contention-based uplink. Use of additional dimensions (e.g. space, code, and/or frequency) may reduce the effect of contention blocking.

For example, an Uplink Request Period (ULP) (or (ULR)) may be set up as (e.g., special and/or extraordinary) SP signaled through the Extended Schedule element (e.g., in the DTI).

For example, an Uplink Request Period may be set up as an (e.g., useful, extraordinary, and/or optional) access period, e.g., signaled in the beacon similar to the A-BFT and/or ATI. STAs may send a Request frame to an AP during this period.

During a ULP (or ULR), an AP may, for example, do one or more of the following: set its receive antenna to a Quasi-Omni antenna, e.g., to allow one or more, or all STAs contend for the medium; set its receive antenna to a Quasi-Omni antenna and/or a group of sectors, e.g., to allow multiple, or one or more, or all STAs to contend for the medium and/or set its receive antenna to a specific sector.

An AP may set its receive antenna to a Quasi-Omni antenna, e.g., to allow one or more, or all STAs contend for the medium. A (e.g. one or more, or each) STA may set its antenna to the best transmit sector that may be identified during a responder TXSS (e.g. in the case of no reciprocity) and/or the best initiator RXSS (e.g. in the case there is antenna reciprocity).

An AP may set its receive antenna to a Quasi-Omni antenna configuration, a specific sector configuration, and/or a group of sectors configuration, e.g., to allow multiple, or one or more, or all STAs to contend for a medium. N slots may be created within the period and/or uplink contention may be restricted to a group of STAs. Grouping criteria may be specified and/or signaled by the AP. For example, STAs may be grouped, for example, based on the best transmit and/or receive sectors identified. For example, an AP may sweep N receive sectors on N slots. An AP may signal receive sector IDs used on one or more, or each, slot implicitly and/or explicitly in a Beacon frame. STAs that may know the best Tx/Rx sector of the AP may choose the corresponding slot to perform a UL request. For example (e.g. where N=M (the number of sectors swept in the beacon frames)) one or more, or each, STA may notice the receive sectors of the AP on one or more, or each, slot and/or may be implicitly assigned a group, e.g., based on its best sector, 1, . . . , M. For, an AP/PCP may assign STAs to groups, e.g., based on their traffic pattern.

An AP may set its receive antenna to a specific sector. A specific sector sweep order may be announced at the beginning and/or the ULP. A sector sweep order may mirror a sector sweep order of beacon frames at the beginning of the beacon period. STAs that may have identified a specific sector as the best sector (and/or as one of the best n sectors when n may be configurable) may compete for the resource to send a request.

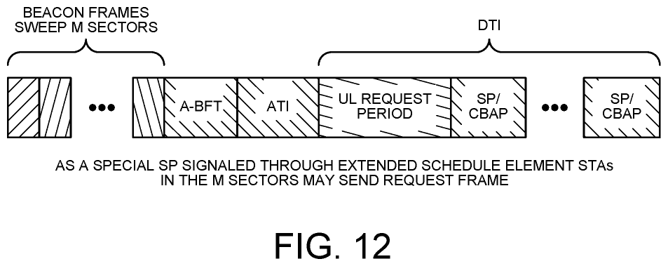

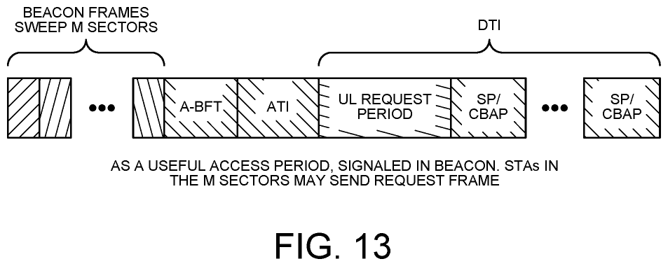

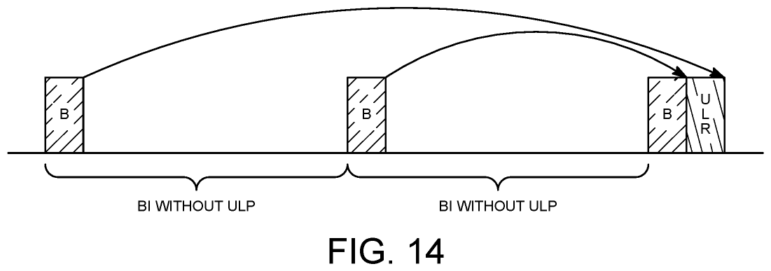

FIG. 12 is an example of an Uplink Request Period in a Data Transmission Interval (DTI). FIG. 13 is an example of an Uplink Request Period as a useful access period. A ULP may (e.g. as shown in FIG. 13) be a period part of a Beacon Head Interval (BHI). The presence of the ULP, perhaps when useful, may be signaled in a current Beacon frame and/or previous Beacon frames (e.g. as shown in FIG. 14). STAs that may receive Beacon frames from a previous BI may preserve an uplink request and/or transmit it in an indicated ULP in a later BI.

FIG. 14 is an example of an Uplink Request Period being omitted in some Beacon Intervals.

An efficient dynamic allocation procedure may be implemented. Signaling and/or operation of one or more, or each, sub-phase may be optimized to enable efficient operation in a dense network.

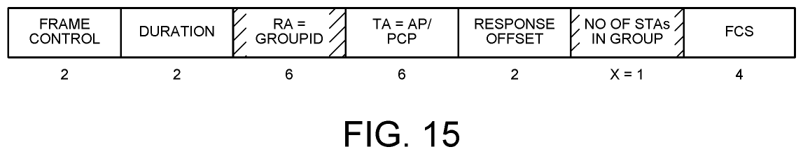

FIG. 15 is an example of a grouped poll. In grouped polling, for example, a PCP/AP may send a poll frame to a group of STAs rather than a single STA. The number of STAs addressed may be indicated to enable the STAs to estimate the proper time to start/end their SPR period.

STAs may be assigned to groups, e.g., with unique groupIDs. A (e.g. each) STA assigned to the group may be given an index within a group, e.g., to ensure that the STA may know what dimension to use for its SPR request. For example, STAa, STAb and STAc may be assigned to group 1 with indices 1, 2 and 3. An AP may poll group 1. The STAs may be aware that during the SPR period, STAa, STAb and/or STAc may send their SPRs in SPR slot 1, slot 2 and/or slot 3, respectively.

STAs may request to join a group. For example, a STA may (e.g. automatically) request to join a group corresponding to its best transmit sector and/or receive sector.

An AP/PCP may explicitly assign STAs with similar traffic request patterns to a group.

An AP/PCP may (e.g. always) assume that (e.g. one or more, or all) STAs within a group may be polled and/or may send the poll with the groupID as the receive address. In a case where a number of STAs in group (x)=1 byte or 8 bits, this may imply a maximum group size of 256 STAs. For example, 24 bytes may be saved for every STA that is polled (e.g. frame control (2), duration (2), RA (6), TA (6), response offset (2) and/or FCS (4) bytes), which may be in addition to PHY header overhead and/or interFrame spacing between bits.

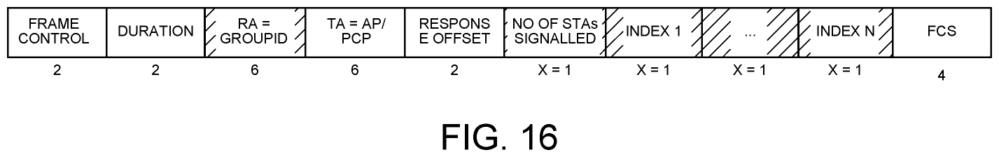

FIG. 16 is an example of a grouped poll with STA indices. An AP/PCP may assume that some STAs within a group may need to be polled. An AP/PCP may send a poll with a groupID as the receive address with a list of the group indices corresponding to the STAs to be polled. In a case where index bit size (x)=1 byte or 8 bits, this may imply a maximum group size of 256 STAs. For example, 24 bytes may be saved for every STA that is polled (e.g. frame control (2), duration (2), RA (6) TA (6), response offset (2) and/or FCS (4) bytes), which may be in addition to PHY header overhead and/or interFrame spacing between bits. The presence of a response offset and/or the number of STAs in group/number of STAs signaled, may (e.g. implicitly) indicate the start and/or duration of an SPR period. A (e.g. each) STA index may (e.g. automatically) assign it an SPR reply dimension. An AP/PCP may (e.g. in the polling procedure) send one or multiple polls for a (e.g. one or more, or each) group.

Efficient grouped SPR may be provided. A (e.g. one or more, or each) STA in the group may (e.g. based on the group polling) estimate its SPR reply dimension and/or may send an SPR to the AP.

For example, an STA may reply on a fixed dimension. For example, STA 256 may reply in SPR dimension 256. A dimension may be one or more (e.g. a combination) of a time slot, a spatial beam, and/or, a code, etc.

For example, an STA may look at a list of STAs in a group that may need to reply and/or may estimate a dimension to reply in. For example, STA1, STA4 and/or STA256 may be grouped together. For example, they reply on SPR dimension 1, 2 and/or 3, respectively.

Efficient grant frames may be provided. For example, a (e.g. legacy) grant frame may be used to allow for any allocation. A single grant frame may be used to indicate a grant to a group of STAs (e.g. simultaneously), for example, by using separate dimensions for one or more, or each, grant.

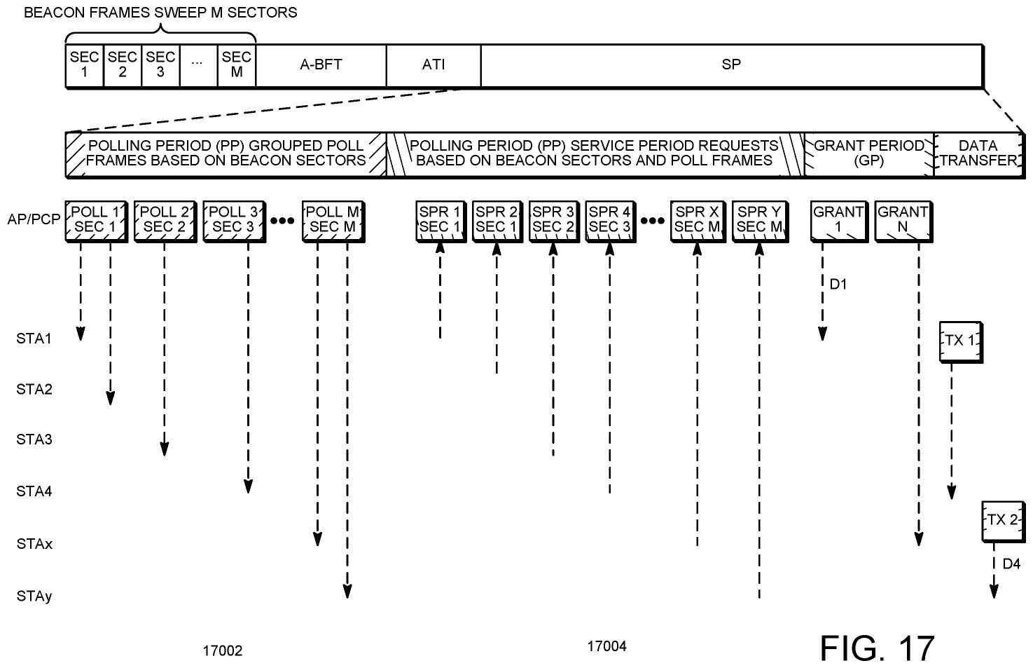

FIG. 17 is an example of efficient Dynamic Allocation. Dynamic allocation with subphase overlap may be provided. AP/PCPs may use the directionality of transmissions in mmWave transmission, for example, to enable spatial re-use transmission and/or potentially different dimensions (e.g. multiple channels, OFDMA), which may allow overlap between different sub-phases of a dynamic allocation procedure. At 17002, there may be a (e.g., single) polling frame for one or more, or each, group, for example. At 17004, one or more, or each, SPR frame may estimate its return dimension from the polling frames, for example. The example of FIG. 17 illustrates a relatively simplified time dimension. Space and/or code may be added for more efficiency, for example.

For example, an AP/PCP may use spatial reuse to allow an overlap of grant and data transmission sub-phases. This may occur, for example, when an AP/PCP grants transmissions that may commence without interfering with an AP's subsequent grant transmissions to other STAs.

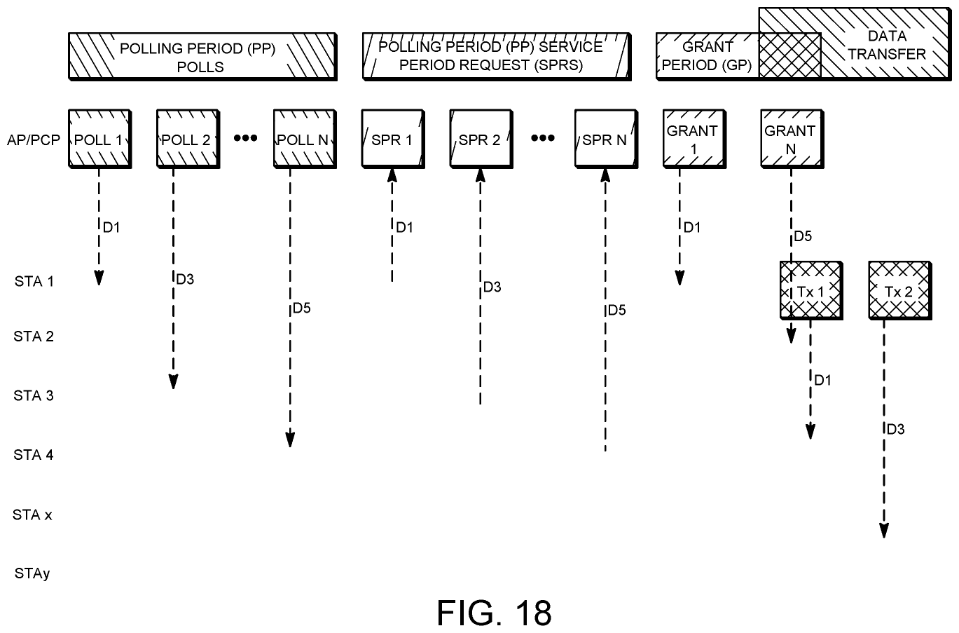

FIG. 18 is an example of a Dynamic Allocation with sub-phase overlap using Spatial Reuse. This may include one or more of the following: the AP/PCP may send a polling frame to the STAs (e.g., in the polling period); STAs may reply with a service period request (e.g., indicating their need for access to the medium); and/or AP/PCP may (e.g., then) start the allocation of resources to the STA.

An AP/PCP may (e.g. in a polling period) send a polling frame to STAs. For example, STA1, STA2 and/or STA4 may be polled.

STAs may reply with a service period request that may indicate their need for access to the medium.

An AP/PCP may start an allocation of resources to the STA. An AP may indicate that STA1 may (e.g. should or must) start its transmission at a time before the end of the grant period. STA1 may start its transmission at the same time as the AP/PCP sends a grant to STA3. This may occur, for example, due to the use of different dimensions and/or the use of spatial reuse. The AP/PCP may grant resources to STA 1, which may (e.g. in turn) transmit data (TX1) to multiple (e.g. two) STAs (e.g. STA 3 and STA4). An AP/PCP may grant resources to STA1 and/or STAx, which may (e.g. in turn) transmit data to STA3 and/or STAy, e.g., respectively. An AP may use knowledge of spatial reuse properties of STAs to allocate resources.

Additional overlap of the polling, service period, grant period and/or data transfer sub-phases may be possible with the use of spatial reuse, for example, when full duplex transmission may be enabled at the AP/PCP.

For example, a system with channel aggregation and/or bonding and/or OFDMA transmission may overlap sub-phases, for example, to allow for (e.g. almost immediate) replies to the sub-phases.

An AP/PCP may start a PP in channel 1 and/or may (e.g. immediately) schedule an SPR in channel 2. A Grant period may be scheduled (e.g. immediately) after the PP on channel 1. A data transfer may be scheduled (e.g. immediately) after the PP: SPRs on Ch2. This pipelining may allow a sub-phase to start before a previous sub-phase is over, which may reduce the delay to the start of data transmission.

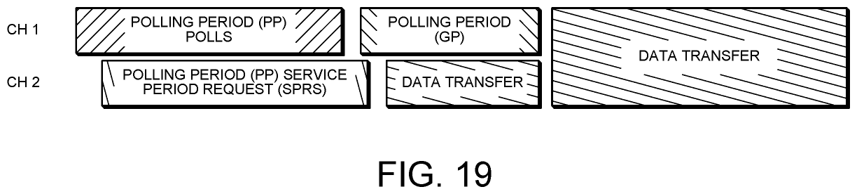

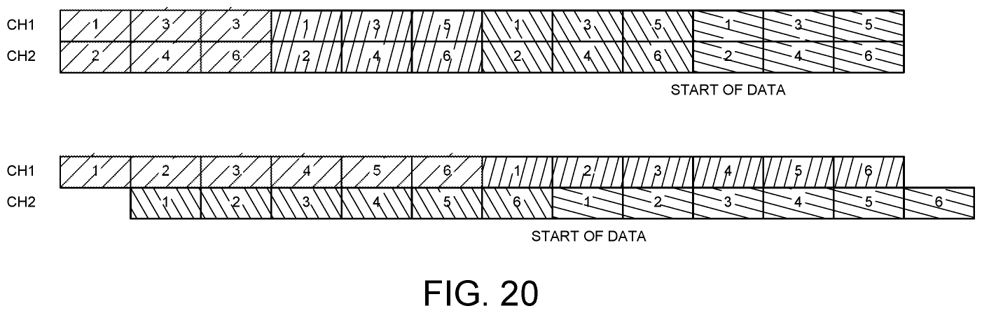

FIG. 19 is an example of dynamic allocation with sub-phase overlap using frequency. FIG. 20 is an example of optimizing the start of data transmission by sub-phase overlap using different dimensions.

DA may be implemented with contention and/or (e.g., multi-dimensional) grants. One or more STA may receive an indication of an Uplink Request Period (ULP) in a transmission period (e.g. DTI, A-BFT, and/or ATI). The ULP may be a dedicated period for contention-based uplink (UL) to request for resources (e.g., transmission resources and/or multi-dimensional transmission resources). The ULP may use 802.11ay dimensions such as, for example, space (MU-MIMO), frequency (channel bonding and/or aggregation), and/or code. The ULP may be set up in the DTI, A-BFT, and/or ATI, for example. The ULP may be set up as (e.g., special and/or extraordinary) SP, perhaps for example signaled through the Extended Schedule element in the DTI. The ULP may be set up as an (e.g., useful and/or optional) access period, perhaps for example signaled in the beacon similar to the A-BFT and/or ATI. One or more STA may evaluate an (e.g., respective and/or group) eligibility to compete for the transmission resources in one or more ULP as described herein. For example, during beam setup, a STA may identify beam X at the AP as its (e.g., relatively) best receive beam. Perhaps for example when beam X is active, then the STA may determine (e.g., automatically) that it is eligible, and/or is in a group that is eligible, to compete for the transmission resources.

An AP may set up its antennas (e.g., an antenna configuration) as a Quasi-omni configuration, in a group of sectors configuration, and/or in a one specific sector configuration. The AP Antenna setup/configuration may determine, at least in part, the group of STA (e.g., eligible STA) that may send an uplink request. Signaling may indicate, at least in part, eligible STA based on AP antenna configuration used, and/or STA grouping, etc. One or more eligible STA may compete for resources to make an UL request to the AP in the ULP. One or more STA may receive one or more grants (e.g., multi-dimensional grants) indicating one or more transmission resources (e.g., multi-dimensional transmission resources). One or more STA may transmit (e.g., multi-dimensionally) to indicated receiver(s).

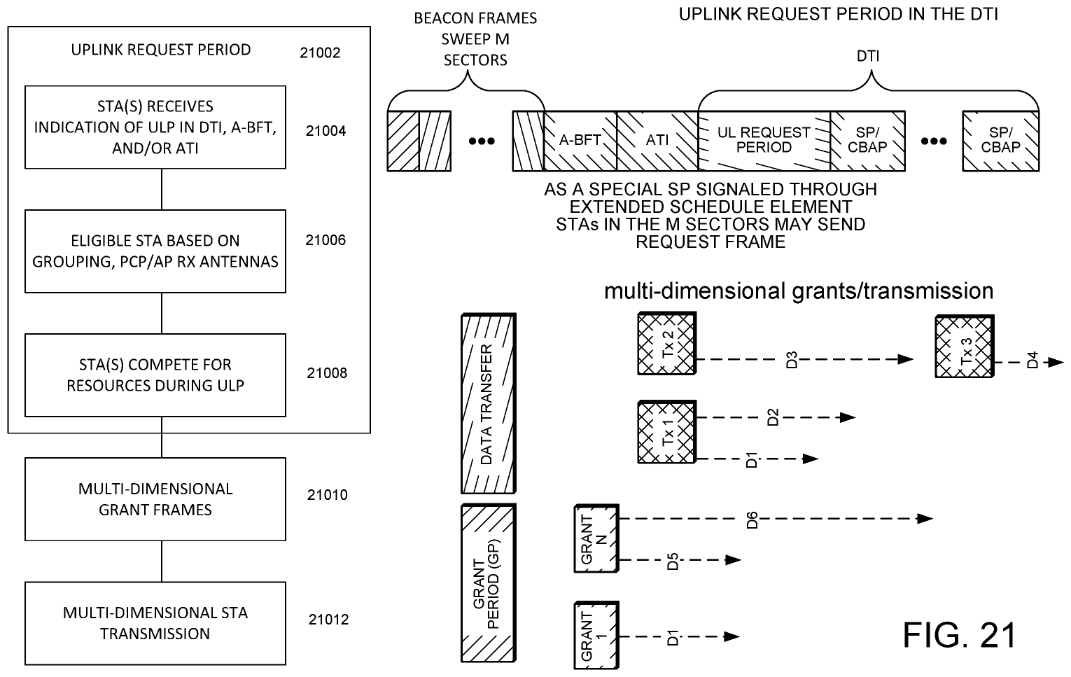

FIG. 21 is an example technique of DA with contention and/or (e.g., multi-dimensional) grants/transmission. At 21002, an Uplink Request Period may include one or more elements of one or more example technique(s). At 21004, one or more STA may receive an indication of ULP in DTI, A-BFT, and/or ATI. At 21006, at least one eligible STA may be determined and/or self-determined for example based on grouping, signaling, and/or AP/PCP Rx antennas configuration(s). At 21008, one or more (e.g., eligible) STA may compete for Resources during ULP. At 21010, one or more (e.g., multi-dimensional) grant frames may be allocated/identified (e.g., by the AP/PCP). At 21012, one or more (e.g., multi-dimensional) STA transmission(s) can be made.

For example, at 21006, a STA may determine if it is eligible, and/or is in a group eligible, to compete for transmission resources. For example, at 21008, one or more such STA may compete for resources. For example, at 21010, an AP/PCP may answer one or more, or all, STA it may detect/hear with one or more (e.g., multi-dimensional) grant frames. For example, at 21010, the AP/PCP may answer one or more STA that the AP/PCP may detect/hear and the AP/PCP itself may deem eligible (e.g., using grouping and/or signaling) with one or more (e.g., multi-dimensional) grant frames.

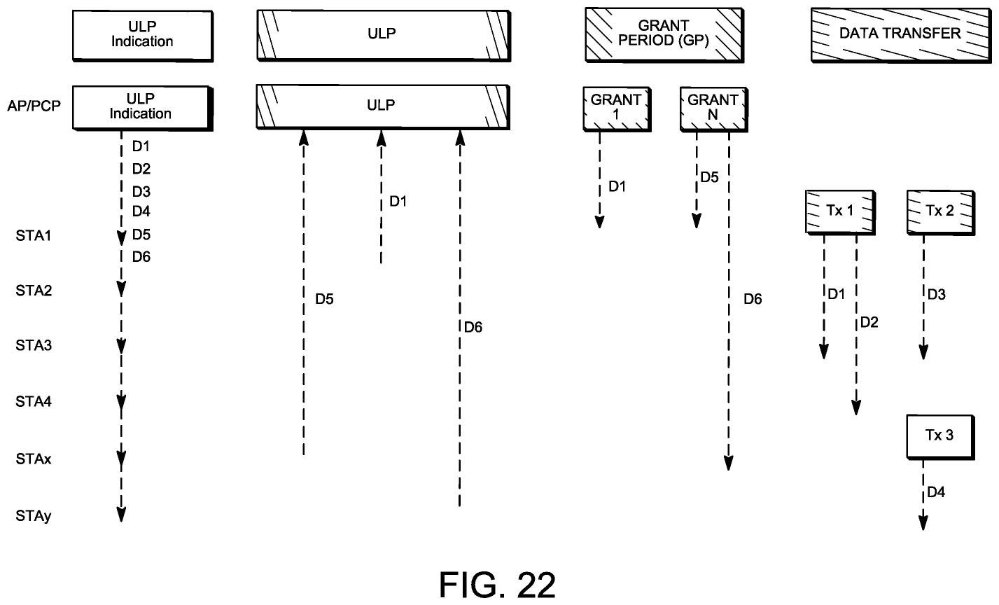

FIG. 22 is an example of multi-dimensional dynamic allocation with multi-dimensional data transfer with ULP data request. One or more of the examples of FIG. 21 may apply to FIG. 22, and vice versa. The AP/PCP may be in communication with a wireless communication network. One or more of the STA1, STA2, STA3, STA4, STAx, and/or STAy may be associated with the wireless communication network, or may be unassociated with the wireless communication network. Unassociated STA may want/seek communication with the wireless communication network. As illustrated in FIG. 22, and as compared with the polling period and/or service period requests shown in FIG. 11, the ULP technique may reduce the overhead and/or may increase the overall efficiency of the resource requests and/or grants.

Features, elements and/or actions are described by way of non-limiting examples. While examples are directed to 802.11 protocols, subject matter herein is applicable to other wireless communications and/or systems. Each feature, element, action, and/or other aspect of the described subject matter, whether presented in figures and/or description, may be implemented alone or in any combination, including with other subject matter, whether known or unknown, in any order, regardless of examples presented herein.

Systems, methods, and/or instrumentalities have been disclosed for dynamic allocation (e.g. of communication channel time with an access point (AP)) to a plurality of wireless transmit/receive units (WTRUs) in dense mmWave networks. Dynamic allocation may be implemented in multiple (e.g. four) sub-phases, (e.g. a polling period sub-phase with polls, a polling period sub-phase with service period requests (SPRs), a grant sub-phase and/or a data transfer sub-phase). Multi-dimensional dynamic allocation may address multiple STAs simultaneously (e.g. using one or more different dimensions such as space, frequency, and/or code). Directional channel access may provide a contention-based uplink in which STAs compete (e.g. during an uplink request period) to send data requests. Efficient dynamic allocation may optimize signaling and operation in sub-phases (e.g. using grouped polling, grouped SPR and/or grouped grant frames). Dynamic allocation with subphase overlap may allow different sub-phases of a dynamic allocation procedure to overlap.

The processes described herein may be implemented in a computer program, software, and/or firmware incorporated in a computer-readable medium for execution by a computer and/or processor. Examples of computer-readable media include, but are not limited to, computer-readable storage media. Examples of computer-readable storage media include, but are not limited to, a read only memory (ROM), a random access memory (RAM), a register, cache memory, semiconductor memory devices, magnetic media such as, but not limited to, internal hard disks and/or removable disks, magneto-optical media, and/or optical media such as CD-ROM disks, and/or digital versatile disks (DVDs). A processor in association with software may be used to implement a radio frequency transceiver for use in a WTRU, terminal, base station, RNC, and/or any host computer.

1. A station (STA), comprising:
a receiver configured at least to:
detect an indication of one or more Uplink Request Periods (ULP) from an Access Point (AP);
a processor configured at least to:
determine an occurrence of at least one ULP of the one or more ULP;
determine an eligibility to request one or more transmission resources in the at least one ULP; and
initiate a request for the one or more transmission resources upon the determination indicating the eligibility; and
a transmitter configured at least to:
send the request for the one or more transmission resources in a contention-based uplink (UL) signal in the at least one ULP.

2. The STA of claim 1, wherein the at least one ULP is a dedicated period for the contention-based UL signal request for the one or more transmission resources.

3. The STA of claim 1, wherein the indication of the one or more ULP is included in at least one of: a Data Transmission Interval (DTI), an Association Beamforming Training Time (A-BFT), or an Announcement Transmission Interval (ATI).

4. The STA of claim 1, wherein the receiver is further configured to:
receive an indication of the one or more transmission resources in response to the request.

5. The STA of claim 1, wherein the one or more transmission resources are multi-dimensional transmission resources.

6. The STA of claim 5, wherein the indication of the one or more multi-dimensional transmission resources includes one or more multi-dimensional grant frames for one or more multi-dimensional transmissions.

7. The STA of claim 5, wherein the transmitter is further configured to:
send one or more multi-dimensional transmissions using the one or more multi-dimensional transmission resources.

8. The STA of claim 1, wherein the one or more ULP are service periods (SP), and the indication of the one or more ULP is included in an Extended Schedule Element.

9. The STA of claim 8, wherein the SP is at least one of: a special SP, or an extraordinary SP, the Extended Schedule Element being included in a Data Transmission Interval (DTI).

10. The STA of claim 1, wherein the processor is further configured such that the determination of the eligibility to request the one or more transmission resources in the at least one ULP is based on at least one of: a receive antenna configuration of the AP, or signaling from the AP.

11. The STA of claim 1, wherein the one or more ULP are access periods, and the indication of the one or more ULP is included in an Association Beamforming Training Time (A-BFT), or an Announcement Transmission Interval (ATI).

12. The STA of claim 1, wherein the one or more transmission resources are one or more multi-dimensional transmission resources that include one or more of: spatial resources, code resources, or frequency resources.

13. The STA of claim 1, wherein the AP is in communication with a wireless communication network, and the STA is at least one of: a STA in association with the wireless communication network, or a STA that is unassociated with the wireless communication network.

14. An Access Point (AP), comprising:
a processor configured at least to:
provide an indication of one or more Uplink Request Periods (ULP) to a plurality of stations (STA), the one or more ULP being dedicated periods for requests of one or more transmission resources; and
determine one or more STA groups based on the plurality of STA;
a receiver configured at least to:
detect one or more requests for the one or more transmission resources in one or more contention-based uplink (UL) signals from one or more STA of the plurality of STA in at least one ULP via one or more AP receive antenna, the processor being further configured to:
provide an indication of the one or more transmission resources to the one or more STA; and
a transmitter configured at least to:
send the indication of the one or more transmission resources to the one or more STA.

15. The AP of claim 14, wherein the processor is further configured to:
set a configuration of the one or more AP receive antenna to at least one of: a Quasi-Omni antenna configuration, a group of sectors configuration, or a specific sector configuration.

16. The AP of claim 14, wherein the one or more transmission resources are multi-dimensional transmission resources, the one or more multi-dimensional transmission resources including one or more of: spatial resources, code resources, or frequency resources.

17. The AP of claim 14, wherein the AP is in communication with a wireless communication network, and one of more of the plurality of STA are at least one of: associated with the wireless communication network, or unassociated with the wireless communication network.
